(19) United States
(12) Patent Application Publication
(10) Pub. No.: US 2014/0213675 A1
(43) Pub. Date: Jul. 31, 2014

(54) BIOPOLYMERIC MATERIAL INCLUDING MODIFIED NATURAL FIBRES AND THE METHOD FOR MANUFACTURING THE SAME

(71) Applicants: POU CHEN CORPORATION, Changhua County (TW); FENG CHIA UNIVERSITY, Taichung (TW)

(72) Inventors: Shu-Yii Wu, Taichung (TW); Shih-Chien Chu, Taichung (TW); Ming-Lei Wang, Taichung (TW); Chih-Hung Ma, Taichung (TW); Ying-Ming Lu, Taichung (TW); Kuo-Ming Lai, Taichung (TW); Tsung-Hsun Ho, Taichung (TW)

(73) Assignees: Feng Chia University, Taichung (TW); POU CHEN CORPORATION, Changhua County (TW)

(21) Appl. No.: 13/863,747

(22) Filed: Apr. 16, 2013

(30) Foreign Application Priority Data
Jan. 31, 2013 (TW) 102103841

(51) Int. Cl. C08K 7/02; C08J 9/00

(52) U.S. Cl. CPC C08K 7/02; C08J 9/0085
USPC 521/82; 524/15

(57) ABSTRACT

A method for producing a biopolymeric material includes milling a non-edible vegetable fiber into a fiber grain; mixing the fiber grain with a solvent to form a slurry; purifying the fiber grain of the slurry to form a purified fiber; esterifying the purified fiber to form an esterified fiber; drying the esterified fiber to form a modified fiber; and mixing the modified fiber with a plastic material to form the biopolymeric material.

### CROSS REFERENCE

The application claims priority from Taiwan Patent Application No. 102103841, filed on Jan. 31, 2013, the content thereof is incorporated by reference herein.

### FIELD OF THE INVENTION

The invention relates to an organic material, and particularly to, a biopolymeric material and a production method of the same.

### BACKGROUND OF THE INVENTION

Since petrochemical materials are depleted day by day, air pollution becomes more serious each day, and global weather is unpredictable, people have been conscious of the demand for exploiting alternative materials. Among these alternative materials, biomaterials are of low carbon dioxide emissions, low pollution, high decomposition, and high biocompatibility, and therefore are favored by the public. For example, in daily used plastic products, such as rain coats, shoes, plastic bags, and dining utensils, their petrochemical materials are partially replaced by biomaterials. Although biomaterials have overcome the foregoing problems, starch is disclosed to be the main source of biomaterials either in U.S. Pat. No. 8,080,596 or in U.S. Pat. No. 8,080,589. Starch is edible and nutrition for humans and animals. Recently, natural and man-made calamities take place world-wide, and some areas of the world have suffered a great deal of food crisis. If starch is overly employed as the main source for biomaterials, a food crisis worse than ever is imminent and unavoidable.

Accordingly, there is a need for making a polymeric material free of crop feedstock, and possessing properties capable of preventing the food crisis from becoming greater.

### SUMMARY OF THE INVENTION

One objective of the invention is to provide a novel polymeric material, which presents the properties desired by the industries and capable of preventing the food crisis from becoming greater.

According to the foregoing and/or other objective, a biopolymeric material is disclosed. The biopolymeric material includes a plastic material and a modified fiber. The modified fiber is obtained by a method comprising the following steps of:
milling a non-edible vegetable fiber into a fiber grain;
mixing the fiber grain with a solvent to form a slurry;
purifying the fiber grain of the slurry to form a purified fiber;
esterifying the purified fiber to form an esterified fiber; and
drying the esterified fiber to form the modified fiber.

Another objective of the invention is to provide a method for producing a biopolymeric material, and the method includes the following steps of:
milling a non-edible vegetable fiber into a fiber grain;
mixing the fiber grain with a solvent to form a slurry;
purifying the fiber grain of the slurry to form a purified fiber;
esterifying the purified fiber to form an esterified fiber;
drying the esterified fiber to form a modified fiber; and
mixing the modified fiber with a plastic material to form the biopolymeric material.

### BRIEF DESCRIPTION OF THE DRAWINGS

FIG. 1 is a flow chart showing a method for producing a biopolymeric material of one embodiment according to the invention.

### DETAILED DESCRIPTION OF THE INVENTION

The detailed description and preferred embodiment of the invention will be set forth in the following content, and provided for people skilled in the art so as to understand the characteristic of the invention.

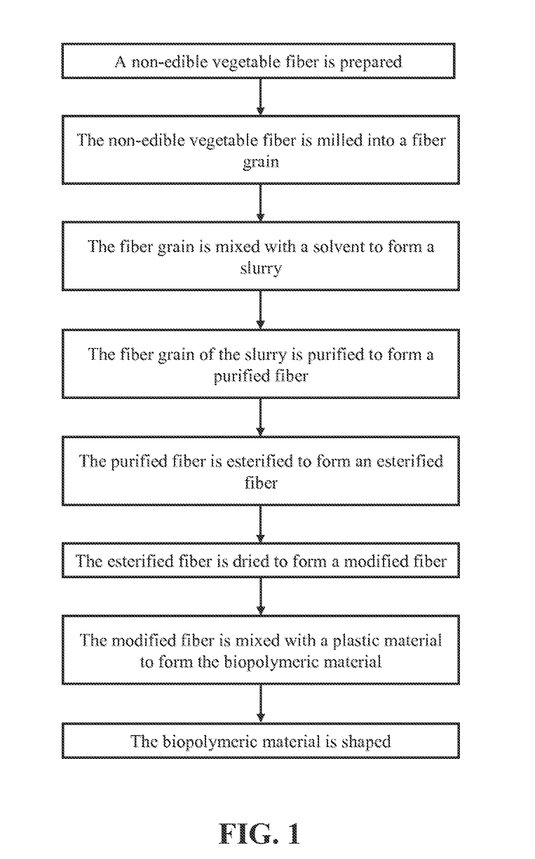

As shown in FIG. 1, a method for producing a biopolymeric material of one embodiment of the invention is illustrated, and its detailed steps are disclosed as below.

Firstly, a non-edible vegetable fiber is prepared. The term “non-edible vegetable fiber” used in this content means a vegetable fiber unsuitable to be eaten by humans and animals. One example is, but not limited to, a rice hull, a rice straw, a bagasse, a rice bran, a wheat bran, a wheat straw, a corn straw, or any combination thereof.

Thereafter, the non-edible vegetable fiber is milled into a fiber grain. In this milling process, the non-edible vegetable fiber is milled into the fiber grain in any commercially purchased milling machine. The grain size of the fiber grain is based on the subsequent use of the biopolymeric material.

Then, the fiber grain is mixed with a solvent to form a slurry. An example of the solvent is, but not limited to, water. In this mixing process, an additive is optionally added to the slurry. An example of the additive is, but not limited to, lactic acid, citric acid, tartaric acid, sodium hydroxide, sodium silicate, ethylene di-amine tetra-acetic acid (EDTA), sodium thiosulfate, magnesium sulfate, surfactant, or any combination thereof

Afterwards, the fiber grain of the slurry is purified to form a purified fiber. In this purifying process, a purifying aid is added to the slurry to form the purified fiber. Furthermore, in this purifying step, the mixture slurry containing the slurry and the purifying aid is optionally stayed at about 70-100° C. for 3-5 hours to form the purified fiber. The term “purifying aid” used in this content means a material which allows the purification of the fiber grain, and its example is, but not limited to, hydrogen peroxide.

Next, the purified fiber is esterified to form an esterified fiber. In this esterifying, an esterifying aid is added to the purified fiber to form the esterified fiber. Additionally, in this esterifying, the mixture containing the esterifying aid and the purified fiber is optionally stayed at 40-50° C. and pH 8.0-8.5 to form the esterified fiber. The term “esterifying aid” in this content means a material which helps the esterification of the purified fiber, and its example is, but not limited to, inorganic acid or acid anhydride. Preferably, the inorganic acid is acetic acid, propionic acid, or any combination thereof. Preferably, the acid anhydride is acetic anhydride, propionic anhydride, or any composition thereof. In one preferable embodiment, the esterification degree of the esterified fiber is of 0.1-0.5.

It is noted that, in this esterifying process, a base is optionally added to the mixture to keep the pH within the demanded range. An example of the base is, but not limited to, sodium hydroxide.

After that, the esterified fiber is dried to form a modified fiber. In this drying process, the esterified fiber is positioned in any commercially purchased granulating machine, and then granulated to form the modified fiber. In one preferable embodiment, the particle size of the modified fiber is of about 10-50 μm, and its water content is of about 2-8%. In this drying process, the esterified fiber is granulated with the purpose to keep the modified fiber's particle size and water content uniform, such that the modified fiber is advantageous for being mixed with other material in the later steps.

Afterwards, the modified fiber is mixed with a plastic material to form the biopolymeric material. In this mixing, the modified fiber is mixed with the plastic material at 100-130° C. for about 6-15 minutes to form the biopolymeric material. The plastic material is variously dependent on the subsequent use of the biopolymeric material. An example of the plastic material is, but not limited to, ethylene-vinyl acetate copolymer (EVA).

For varying the subsequent use of the biopolymeric material, an admixture is added to the modified fiber and the plastic material to form the biopolymeric material. In one preferable embodiment, the amount of the plastic material is of 40-80 parts by weight, the amount of the modified fiber is of 20-60 parts by weight, and the amount of the admixture is of 14-40 parts by weight.

Besides, the admixture includes 10-30 parts by weight of a filling material, 2-5 parts by weight of a foaming agent, 0.8-1.0 parts by weight of a crosslinking agent, 0.8-1.2 parts by weight of a processing aid, and 1-5 parts by weight of a foaming aid. An example of the filling agent is, but not limited to, calcium carbonate, talcum powder, magnesium carbonate, kaolin, or any combination thereof. An example of the crosslinking agent is, but not limited to, peroxide. In one preferable embodiment, the crosslinking agent is dicumyl peroxide (DCP). An example of the processing aid is, but not limited to, stearic acid. An example of the foaming aid is, but not limited to, zinc oxide.

Finally, the biopolymeric material is shaped for its subsequent use. In one instance, the biopolymeric material is placed in a twin roller to be in the form of sheets. After which, a suitable number of the sheets are positioned in a heated compression mold at 165-175° C. and 160-200 kg/cm² for 20-40 minutes, and crosslinking reaction and foaming reaction are performed to form a foam sheet. The foam sheet may be employed as a shoe insole or a sole pad after being cut. In another instance, the biopolymeric material is placed in a pelletizing machine to be in the form of pellets. After which, these pellets are positioned in an injection molding machine at 165-180° C. and 160-200 kg/cm² to form a foam sheet. The foam sheet may be employed as a shoe outsole or a shoe insole.

The following examples are provided for further description of the invention.

### EXAMPLE 1

A rice hull grain of 7,648 gram is mixed with water, and a rice hull slurry is obtained. The additives as listed in TABLE 1 are added to and mixed well with the rice hull slurry, and then, the rice hull slurry is heated to 85° C. At this temperature, a 50% peroxide solution of 303 gram is added to the rice hull slurry. After which, the mixture slurry thus obtained is stayed at this temperature for 4 hours, and purification reaction is performed to form a purified fiber.

TABLE 1

| Composition | Amount (gram) |
|---|---|
| Lactic acid | 15,629 |
| Citric acid/tartaric acid | 260 |
| Sodium hydroxide | 1,000 |
| Sodium silicate | 150 |
| Surfactant | 100 |
| EDTA | 100 |
| Sodium thiosulfate | 100 |
| Magnesium sulfate | 100 |

Purified fiber of 35-40 wt % is added to a suitable amount of a sodium hydroxide solution, and the pH of the purified fiber is maintained in a range of 8.0-8.5. Thereafter, acetic anhydride of 7,648 gram is gently added to the purified fiber, and if necessary, a sodium hydroxide solution is added to the purified fiber to keep the purified fiber's pH in this range. At the pH, the mixture thus obtained is heated to 40-50° C., the mixture is stayed at this temperature for 4-6 hours, and esterification reaction is performed to form an esterified fiber.

The esterified fiber is atomized into a high temperature dryer at a rate of 0.5-1.5 liter/hour via a two-phase nozzle. The inlet temperature of the high temperature dryer is of 170-210° C., and its outlet temperature is of 70-110° C.. Following this atomization, the esterified fiber is in the form of micro-liquid pellets, and due to the heat of the high temperature dryer, the esterified fiber then vaporizes to form a dry powder, a modified fiber.

### EXAMPLE 2

The modified fiber of 1,000 gram is mixed with EVA of 2,300 gram, talcum powder of 495 gram, foaming agent (Azotype) of 99 gram, crosslinking agent (DCP) of 33 gram, stearic acid of 33 gram, and zinc oxide of 66 gram. The blend thus obtained is mixed well and placed in a kneader mixer. With the kneader mixer being turned on, the blend is mixed at 120° C. for 6-15 minutes, and a biopolymeric material is obtained.

### EXAMPLE 3

The biopolymeric material is placed in a twin roller, and then, in the form of sheets. Several of these sheets are placed in a heated compression mold at 165±2° C. and 160-200 kg/cm² for 20-30 minutes, and the sheets are crosslinked and foamed to form a foam sheet. Finally, the foam sheet is taken out, and selectively cut into a desired size so as to be employed as a shoe insole or a shoe pad.

### EXAMPLE 4

Physical properties of the foam sheet are determined using the standard test methods, and their results are shown in TABLE 2. From this table, it's learned that the foam sheet of the example has physical properties meeting the requirements for the industries.

TABLE 2

| Test Item | Test Standard | Result |
|---|---|---|
| Hardness (Asker C) | ASTM D2240 | 55-57 |
| Density (g/cm³) | ASTM D297 | 0.199-0.210 |
| Tensile strength (kg/cm²) | ASTM 412 | 18.9-21.2 |
| Elongation (%) | ASTM D412 | 188.2-208.7 |
| Tear strength (kg/cm) | ASTM D624 | 10.0-13.8 |
| Peel strength (kg/cm) | ASTM D3574 | 2.23-2.30 |
| Rebound (%) | ASTM D2632 | 41-43 |
| Compression set (%) | ASTM D395 50° C. *6 hrs | 53.86-76.40 |
| Esterification degree | — | 0.19-0.20 |

As described above, the modified fiber is made from the non-edible vegetable fiber via a series of steps, and then mixed with the plastic material. Because the non-edible vegetable fiber, different from the prior edible starch, is inedible, a food crisis may be relieved. In another aspect, the modified fiber is formed from the non-edible vegetable fiber and thus, provides with high contact areas for the plastic material so as to enhance compatibility between the modified fiber and the plastic material. In yet another aspect, the biopolymeric material's product in the foregoing embodiment and examples still exhibits properties desired in the industries.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A biopolymeric material, comprising:
a plastic material; and
a modified fiber obtained by a method including:
milling a non-edible vegetable fiber into a fiber grain;
mixing the fiber grain with a solvent to form a slurry;
purifying the fiber grain of the slurry to form a purified fiber;
esterifying the purified fiber to form an esterified fiber; and
drying the esterified fiber to form the modified fiber.

2. The material as claimed in claim 1, wherein the plastic material is ethylene-vinyl acetate copolymer (EVA).

3. The material as claimed in claim 1, wherein the non-edible vegetable fiber is selected from a group consisting of a rice hull, a rice straw, a bagasse, a rice bran, a wheat bran, a wheat straw, and a corn straw.

4. The material as claimed in claim 1, wherein the modified fiber has a particle size of 10-50 μm, and a water content of 2-8%.

5. The material as claimed in claim 1, further comprising: an admixture.

6. The material as claimed in claim 5, wherein the plastic material has an amount of 40-80 parts by weight, the modified fiber has an amount of 20-60 parts by weight, and the admixture has an amount of 14-40 parts by weight.

7. The material as claimed in claim 5, wherein the admixture comprises a filling material, a foaming agent, a crosslinking agent, a processing aid, and a foaming aid.

8. A method for producing a biopolymeric material, comprising the steps of:
milling a non-edible vegetable fiber into a fiber grain;
mixing the fiber grain with a solvent to form a slurry;
purifying the fiber grain of the slurry to form a purified fiber;
esterifying the purified fiber to form an esterified fiber;
drying the esterified fiber to form a modified fiber; and
mixing the modified fiber with a plastic material to form the biopolymeric material.

9. The method as claimed in claim 8, wherein the non-edible vegetable fiber is selected from a group consisting of a rice hull, a rice straw, a bagasse, a rice bran, a wheat bran, a wheat straw, and a corn straw.

10. The method as claimed in claim 8, wherein the solvent is water.

11. The method as claimed in claim 8, wherein the fiber grain mixing step further comprising a step of adding an additive to the slurry.

12. The method as claimed in claim 8, wherein the fiber grain purifying step further comprises a step of adding a purifying aid to the slurry.

13. The method as claimed in claim 12, wherein the purifying aid is hydrogen peroxide.

14. The method as claimed in claim 8, wherein the esterified fiber has esterification degree of 0.1-0.5.

15. The method as claimed in claim 8, wherein the purified fiber esterifying step further comprises a step of adding an esterifying aid to the purified fiber.

16. The method as claimed in claim 15, wherein the esterifying aid is selected from a group consisting of inorganic acid and acid anhydride.

17. The method as claimed in claim 8, wherein the modified fiber has a particle size of 10-50 μm, and a water content of 2-8%.

18. The method as claimed in claim 8, wherein the modified fiber mixing step further comprises a step of adding an admixture to the modified fiber and the plastic material.

19. The method as claimed in claim 8, further comprising a step of: shaping the biopolymeric material.
